(19) United States
(12) Patent Application Publication
(10) Pub. No.: US 2024/0334882 A1
(43) Pub. Date: Oct. 10, 2024

(54) DECORATIVE WREATH SYSTEM

(71) Applicant: Jennafer Diane Williams, White Plains, MD (US)

(72) Inventor: Jennafer Diane Williams, White Plains, MD (US)

(21) Appl. No.: 18/619,713

(22) Filed: Mar. 28, 2024

Related U.S. Application Data
(60) Provisional application No. 63/494,310, filed on Apr. 5, 2023.

(51) Int. Cl. A01G 5/04

(52) U.S. Cl. CPC A01G 5/04

(57) ABSTRACT

A festive wreath system secures to, or drapes over, at least a portion of an object having preselected length, width, and height values. The wreath system includes multiple festive lights, at least one battery to electrically energize each of the lights, and a cord for connecting the battery to each light. The wreath system also includes a length of festive garland, a strap, and a buckle.

### REFERENCE TO RELATED APPLICATION

The present nonprovisional patent application is based on U.S. provisional patent application Ser. No. 63/494,310 filed Apr. 5, 2023, hereby incorporated by reference in its entirety for purposes of priority pursuant to Title 35, United States Code, Section 120.

### FIELD

The present subject matter, generally directed to winter wreaths and such, is more particularly directed to decorative wreaths that can be integrated into seasonal displays.

### BACKGROUND

Most holiday and/or memorial wreaths are manufactured for their intended uses, which are often for mounting to walls, doors, and/or stands or to be placed upon hallowed ground including graves. Wreaths are thus frequently made to be rigid or mostly inflexible.

While U.S. Pat. No. 2,983,472 to Bowling discloses wreath supports for gravestones, U.S. Pat. No. 6,667,079 to Glenn discloses a decorative artificial wreath that can be modified to render the wreath useful for various seasons. The wreath, formed of a frame with back and front sections covered with artificial foliage and including a plant material holder, may include a perforated cover spaced between the frame sections at a lower portion of the frame. To support removable seasonal objects from the frame, pins may extend toward the front of the wreath. Plant-based materials, artificial and/or natural, may be placed in the holder, and an assortment of seasonal objects, held by pins, may adapt the wreath to different seasons or occasions for providing an alternative to purchasing several wreaths.

While US design patent D848,826 to Williams discloses eight embodiments for an over-the-door wreath hanger, U.S. Pat. No. 11,076,534 to Kacines discloses an adjustable over-the-door support for hanging items at predetermined vertical locations with respect to a door. The support includes a hanger for engaging an upper edge portion of the door.

U.S. Pat. No. 1,482,537 to Alter et al. depicts a wreath of two-piece construction. Each piece has an open-end portion and a tapered opposite-end portion. The tapered-end portion of one of the pieces is sized to fit into the open-end portion of the other. U.S. Pat. No. 5,503,883 to Kell, Jr. et al. describes a wreath made of a biodegradable ring. U.S. Pat. No. 1,517,287 to Hanson discloses a wreath made from a plurality of hoop elements; while U.S. Pat. No. 1,812,116 to Propp shows a wreath decorated with an electric-powered candle.

US 2009/0317568 to Hruska discloses a miniature wreath constructed of a rigid annular ring containing one or more single-strand garland rope segments presented in an intertwined arrangement, where each single-strand garland rope segment contains two metal wires and at least one ribbon strand from which a plurality of needles protrudes in multiple directions, and where the metal wires and the ribbon strands are also intertwined.

U.S. Pat. No. 9,357,713 to Sharpe discloses a reusable wreath frame assembly sized and configured to receive and retain a quantity of wreath material. The frame assembly includes a frame adapted to form the back of a wreath. A multi-link fastening assembly secured to the frame and adapted to become a fixed arrangement extends from the frame and is wrapped around the wreath material to secure the material to the frame. Wreath material supported on the frame assembly may be removed at the end of a season. The frame assembly may be stored and later reused to hold and support new wreath material.

While decorative wreaths are often rigid and/or inflexible, certain members of the public would rather have wreaths, adjustable to preselected dimensions, be commercially available, for enabling the wreaths to be hung from or wrapped around a variety of objects.

The present subject matter is directed to a decorative wreath that can be hung from or draped over many objects that present a variety of “hanging constraints” such as diameter or width of such an object, thereby eliminating concerns about securely fixing the wreath to an object. The present subject matter, a genuine improvement over the prior art, is made by wrapping a garland including lights powered by an electric current around an object, while adjusting length of the garland and the electric cord that powers the lights.

### SUMMARY

The present subject matter is directed to an adjustable wreath with a feature that allows the wreath to be fitted around irregularly shaped objects. An adjustable length feature provides a much greater range of use when wreaths are employed for decorative purposes. In an embodiment, a length-adjustment mechanism includes a quick-release buckle, to enable the wreath to be wrapped around a variety of irregularly shaped objects.

A festive wreath system adapted for securing to, or draping over, at least a portion of an object having preselected length, width, and height dimensions is summarized as follows: The wreath system includes a plurality of festive light bulbs, at least one battery to electrically energize each of the bulbs, and a cord for connecting the battery to each bulb. The wreath system also includes a length of festive garland, a strap, and a buckle.

The cord has a predetermined length and an end portion connected to the battery. Each of the light bulbs is seriatim connected to a major portion of the length of the cord for providing electrical power to each of the light bulbs. A predetermined length of festive garland extends from, and is wrapped around, the major portion of the length of the cord. The garland has opposite end portions. The strap has a predetermined length and width. The strap includes a pair of spaced-apart opposite end portions. The buckle, designed for securing the opposite end portions of the strap together, is openable and closeable to enable the wreath system to be secured to, or draped over, at least a portion of the object.

Wrapping a lit garland around an object involves managing lengths of the garland and a cord to power the lights. With commercially available wreaths, a fixed circumference of an object and a diameter of a wreath either excludes using commercial wreaths due to their dimensions or otherwise limits other options available to a user. For the wreath of the present subject matter, an adjustable-length feature enables members of the public to design a variety of decorative, custom, seasonal wreaths. The present subject matter, a self-contained decorative wreath adjustable to a predetermined diameter or width of a plurality of objects, is easily wrapped around an object to secure the wreath to the object.

### BRIEF DESCRIPTION OF THE DRAWING FIGURES

FIG. 1 is a front elevational view of an embodiment of the present subject matter.

FIG. 2 is an exploded detail view thereof, taken along arc 2-2.

FIG. 3 is another detail view thereof.

FIG. 4 is another front elevational view, shown in use as an integrated seasonal display.

Throughout the figures and detailed description, similar alphanumeric references are used to refer to features of the present subject matter that are either similar or related.

### DETAILED DESCRIPTION

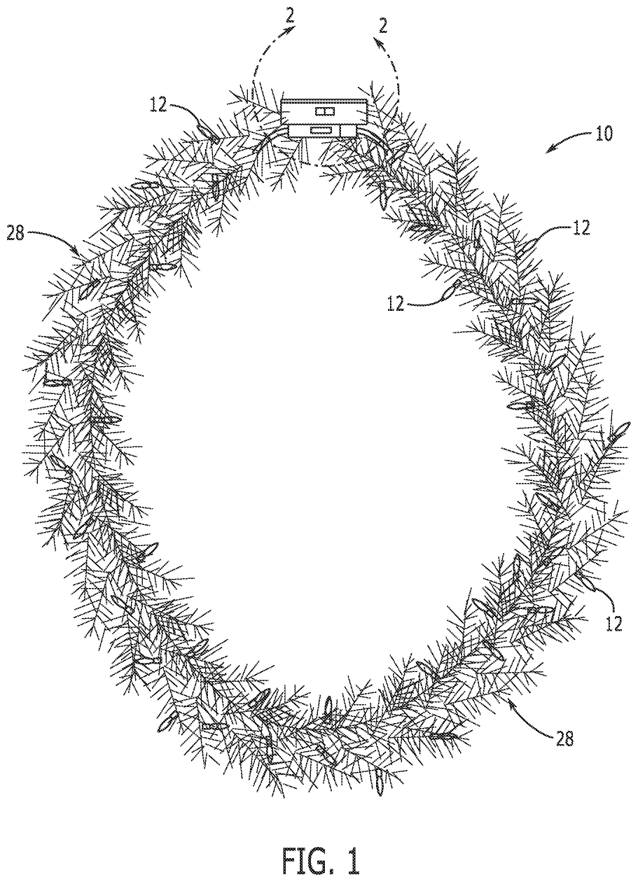

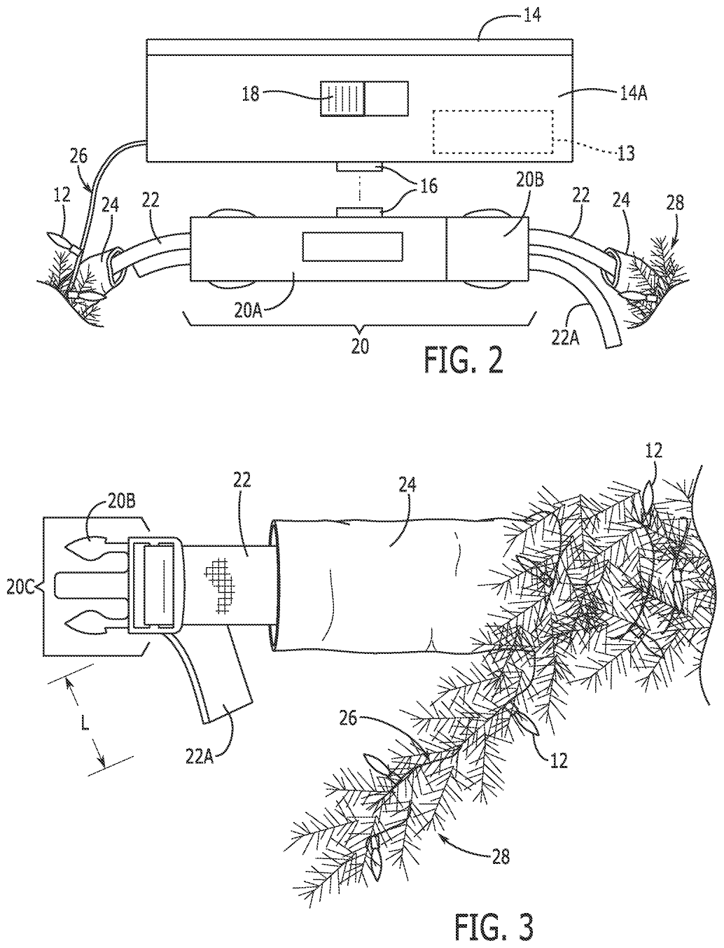

A decorative wreath system 10 (FIG. 1) dimensionally adaptable and configurable for removably securing to, or draping over, at least a portion of an object of predetermined length, width, and height dimensions or preselected length, width, and height values shall now be described in detail. The wreath system 10 comprises: a plurality of light bulbs 12, each of which is capable of being electrically energized. The wreath system 10 includes at least one battery 13 (FIG. 2) capable of electrically energizing each of the plural light bulbs 12. The wreath system 10 includes an electrical cord 26 of predetermined length and having an end portion operatively connected to battery 13. All the light bulbs 12 (hereinafter simply lights 12) are seriatim connected to a major portion of the length of the cord 26 for providing electrical current to each of the plural lights 12. The wreath system 10 of the present subject matter further includes a predetermined length of festive garland 28 extending from the major portion of the length of electrical cord 26. Festive garland 28 has opposite end portions. The decorative wreath system 10 includes a strap 22 having a predetermined length and a predetermined width. Strap 22 has a pair of spaced-apart end portions. Wreath system 10 includes a buckle 20 secured to these strap end portions.

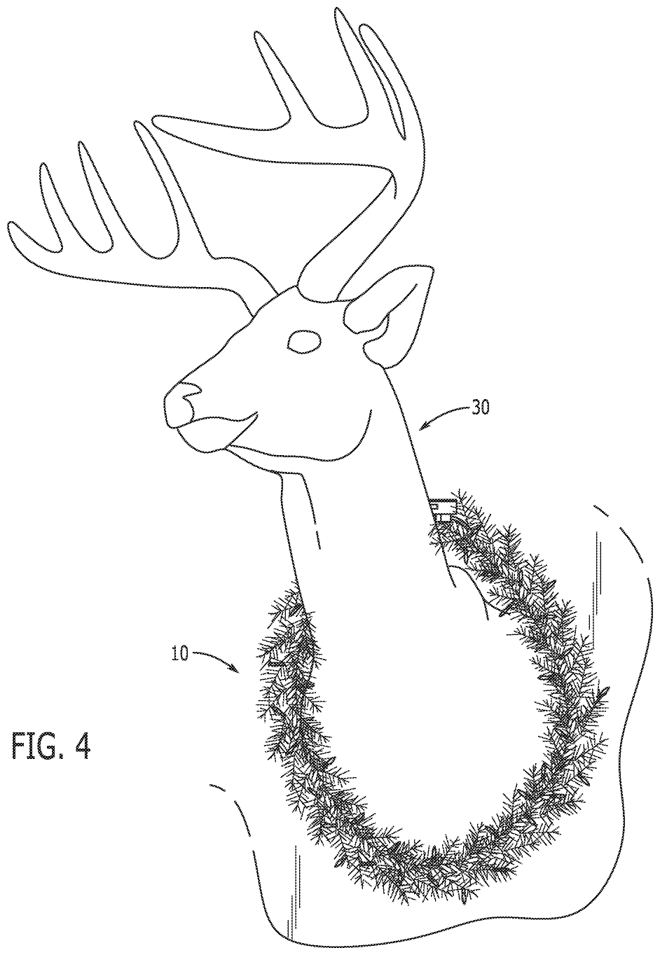

The buckle 20 is adapted and configured to be openable and closeable for enabling the decorative wreath system 10 to be secured to, and/or draped over, at least a portion of an assortment of preselected objects. One such object 30 may be a wall-mounted deer trophy, and the portion of such an object over which the decorative wreath system 10 of the present subject matter is to be secured to, or draped over, may be the neck portion of a deer or another reindeer surface. (Please refer to FIG. 4.) In other embodiments of the present subject matter, each of the lights 12 could be a “smart bulb” or an “LED” light. A major portion of the predetermined length of the festive garland 28 may be helically wrapped around the length of strap or belt 22. Also, strap 22 may be manufactured from nylon. Buckle 20 comprises a female end portion 20A (FIG. 2) and a male end portion 20B (FIG. 3) engageable with the female end portion 20A. The female end portion 20A of buckle 20 and the male end portion 20B of buckle or connector 20 are snap-engageable. The wreath system 10 includes a predetermined length of sleeve 24. The length of sleeve 24 is dimensioned and configured for enclosing a major portion of the length of the strap 22, except for the end portions of the strap 22. (See FIGS. 2, 3.) A major portion of predetermined length of festive garland 28 is helically wrapped around a major portion of the length of sleeve 24 while the length of strap 22 is within the length of sleeve 24. One of the opposite end portions of strap 22 may include an integral extra length 22A (of strap 22) for adjusting the length of strap 22 around a particular object. The integral extra length 22A (which may be longer than shown in FIG. 3) extends around an integral cross-bar portion 20C (FIG. 3) of the male end portion 20B (of the buckle or connector 20). For preselected events, to custom-fit the decorative wreath system 10 of the present subject matter around a preselected object, the female and male end portions 20A, 20B of buckle or connector 20 are separated. The sleeve 24 is then secured to, or draped over, at least a portion of the preselected object. Next, end portions 20A, 20B of buckle 20 are joined together. Finally, a length L (FIG. 3) of extra length portion 22A (of belt 22) is adjusted, by increasing or decreasing the length L, to provide a desired custom-fit decorative seasonal wreath. (FIG. 4.) In embodiments, the wreath system 10 may include a compartment 14A for battery 13. (FIG. 2.) A cover 14, secured to compartment 14A, covers the battery 13.

In embodiments, the wreath system 10 of the present subject matter may also include an electric-power switch 18 operatively connected between the battery and the end portion of the electrical cord 26. The switch 18 is a multipurpose component which may be actuatable between an “on” setting to electrically energize each of the lights 12, through a series of light pattern settings (such as about 4 patterns) and an “off” setting to de-energize all the lights 12. Another switch (not shown) may be actuatable via a wireless connection between the various settings by a commercial remote-control device (not shown).

In embodiments, the wreath system 10 of the present subject matter may include a pair of magnets 16. In operation, magnets 16 are designed to be magnetically attracted to each other, whereby one of the magnets 16 (FIG. 2) may be fixed to the buckle 20, and the other one of the magnets 16 may be fixed to the compartment 14A, whereupon the magnets 16 cause the battery compartment 14A and buckle 20 to be magnetically joined.

In embodiments, the sleeve 24 may be a 4.5 inch-wide by 41.5-inch long strip of fabric, with a ½-inch hem on each shorter edge portion and a seam, hand-sewn or machine-sewn, connecting the two longer edge portions to form a tubular sleeve 24. In embodiments, there is enough festive garland 28 to fully encircle a full length of the sleeve 24. In other embodiments, there is enough garland 28 to conceal the sleeve 24 from view.

In embodiments, an attachment means may be used to secure the battery compartment 14A to the buckle 20. The attachment means may be selected from the group consisting of magnetic connectors, Velcro® dots, i.e., adhesive hook and loop fasteners, hooks, and/or loops may be used.

Illustrated and described in detail in this patent specification is a decorative wreath system. While the present subject matter is described with reference to an illustrated embodiment, the present subject matter is not limited to the present embodiment. On the contrary, many alternatives, changes, and/or modifications shall become apparent to a person of ordinary skill in the art (“POSITA”) after this patent specification and its accompanying figures are reviewed. Therefore, all such alternatives, changes, and/or modifications are to be considered as constituting a part of this disclosure of the present subject matter insofar as they fall within the spirit and the scope of the appended claims.

I claim:

1. A decorative wreath system (10) dimensionally adaptable for securing to or draping over at least a portion of an object having preselected length, width, and height values,
wherein the decorative wreath system (10) comprises:
a plurality of lights (12), each of which is capable of being electrically energized;
at least one battery capable of electrically energizing each of the plural lights (12);
an electrical cord (26) of predetermined length and having an end portion operatively connected to the at least one battery, wherein each of the plural lights (12) is seriatim connected to a major portion of the length of the electrical cord (26) for providing electrical power to each one of the plural lights (12);
a predetermined length of festive garland (28) extending from said major portion of said cord length, wherein said garland (28) has opposite end portions;
a strap (22) having a predetermined length and a predetermined width, wherein the strap (22) includes a pair of spaced-apart opposite end portions; and
a buckle (20) for securing the opposite end portions of the strap (22) together,
wherein the buckle (20) is adapted to be openable and closeable for enabling the wreath system (10) to be secured to or draped over at least a portion of the object.

2. The decorative wreath system (10) of claim 1, wherein the object is a wall-mounted deer trophy, and wherein the portion of the object is the neck or another reindeer surface.

3. The wreath system of claim 1, wherein each of the plural lights (12) is an LED light.

4. The decorative wreath system (10) of claim 1, wherein a major portion of the predetermined length of festive garland (28) is helically wrapped around the strap (22).

5. The wreath system of claim 1, wherein the strap (22) is manufactured from nylon.

6. The wreath system of claim 1, wherein the buckle (20) comprises a female end portion (20A) and a male end portion (20B) engageable with the female end portion (20A).

7. The system of claim 6, wherein the female and male portions are snap-engageable.

8. The decorative wreath system (10) of claim 1, further including a predetermined length of sleeve (24), wherein the length of sleeve (24) is dimensioned and configured for enclosing a major portion of the length of the strap (22) except for the end portions thereof.

9. The decorative wreath system (10) of claim 8, wherein a major portion of the predetermined length of festive garland (28) is helically wrapped around the sleeve (24).

10. The wreath system (10) of claim 1, wherein one of the opposite end portions of the strap (22) includes an integral extra length (22A) for adjusting length of the strap (22), and wherein the strap extra length (22A) is secured to the buckle male end portion (20B).

11. The decorative wreath system of claim 1, further comprising a compartment (14A) and a cover (14) engageable with the compartment for containing the at least one battery.

12. The wreath system (10) of claim 11, further comprising a switch (18) operatively connected between the at least one battery and the electrical cord end portion, wherein the switch (18) is actuatable between an on position to electrically energize each one of the plurality lights (12) and an off position to de-energize each of the plural lights.

13. The wreath system of claim 11, further comprising an attachment means operative to attach the buckle (20), to the compartment (14A), wherein the attachment means is selected from the group consisting of a pair of magnets (16) adapted to be magnetically attracted to each other; hooks; loops; adhesive hook and loop fasteners; and any combination thereof.
